(19) United States
(12) Patent Application Publication
(10) Pub. No.: US 2017/0261022 A1
(43) Pub. Date: Sep. 14, 2017

(54) CORNER CONNECTOR FOR ROD-SHAPED PROFILE ELEMENTS

(71) Applicant: Eckhard SCHIRMER, Diessen am Ammersee (DE)

(72) Inventor: Eckhard SCHIRMER, Diessen am Ammersee (DE)

(21) Appl. No.: 15/500,136

(22) PCT Filed: Jul. 31, 2015
(86) PCT No.: PCT/EP2015/067753

§ 371 Date: Jan. 30, 2017

(30) Foreign Application Priority Data
Aug. 1, 2014 (DE) 10 2014 215 254.2

(51) Int. Cl. F16B 12/44; A47B 47/00; A47B 81/00; A47F 5/10

(52) U.S. Cl. CPC F16B 12/44; A47F 5/10; A47B 47/0016; A47B 81/00; F16B 2012/443; F16B 2012/446

(57) ABSTRACT

A corner connector for rod-shaped profile elements, with a connection element which comprises at least two attachment portions which are oriented substantially perpendicular to each other and which are each designed such that an attachment portion and a front end of the rod-shaped profile elements to be connected engage in each case one inside the other, at least one transverse strut of which the ends are designed such that an end of the transverse strut and a connection portion provided on a lateral surface of the rod-shaped profile elements to be connected in each case engage releasably one inside the other, and a clamping element which clamps the transverse strut releasably against the corner connector. An assembly system composed of such corner connectors and supporting or holding frames composed of such corner connectors and profile elements.

The present invention relates to a corner connector for rod-shaped profile systems, to an assembly system which comprises a plurality of different corner connectors of this type, and to a load-bearing or holding frame which is assembled from profile elements, at least two profile elements being connected to one another via a corner connector.

A load-bearing or holding frame of this type is described, for example, in German patent specification DE 197 34 350 C1 from the applicant. The known load-bearing or holding frame has an inner frame or an object which is held around the holding frame and stabilizes the frame overall via tensile connections, with the result that the profile elements and corner connectors which form the frame can be configured as simple plug-in connections and can be assembled without further fastening means. The fact that the use possibilities of tensioning systems which are provided in the interior of the frame are restricted is a disadvantage of the known frame. In particular, if non-square rectangular geometries are used, an inner frame for absorbing the tensioning forces is required, since diagonally running tensioning cables can no longer be used, at least if individually adapted corner connectors are not to be used.

In woodworking craftwork, in particular at joineries and carpenters, panels which are connected to one another to form a corner are frequently additionally stabilized by way of transverse struts or transverse panels. Here, the ends of the transverse struts are usually screwed to the panels. The British patent application GB 2391802 A describes a bed frame which can be dismantled and consists of four side cheeks which are connected to one another via four corner posts. In order to form a corner connection, two side cheeks are pressed with their end faces against corresponding stop faces of the corner post. This takes place with the aid of two corner struts which, at their ends, have projections which engage into openings of the side cheeks. The transverse struts are screwed to the corner connector and thus pull the side cheeks in the direction of the corner connector.

The connecting technique which is described in GB 2391802 A is not suitable for frames and frameworks comprising rod-shaped profile elements, since it requires at least two corner connectors per corner for a stable connection. Even then, the construction which is described in the prior art cannot absorb any appreciable forces which act between the corner post and the side cheeks, and is therefore suitable only for the application described there of a bed frame, where the forces which are exerted by way of slatted frame, mattress and user act substantially perpendicularly downward and parallel to the stop faces between the corner post and the side cheeks. Furthermore, more complex frames or frameworks cannot be constructed using the corner connector which is known from GB 2391802 A, since the known corner connector is suitable only for a maximum of two side cheeks.

The present invention is based on the technical problem of providing a corner connector for rod-shaped profile elements, by way of which corner connector rod-shaped profile elements can be assembled in a more simple and more stable way, and which also makes the construction of more complex frames and frameworks from said rod-shaped profile elements possible, in particular frameworks which extend in all spatial directions.

Said technical problem is solved by way of the corner connector as claimed in the present claim 1. Advantageous developments of the corner connector according to the invention are subjects of the dependent patent claims.

Accordingly, the subject matter of the present invention is a corner connector for rod-shaped profile elements, having a connecting element which comprises at least two connector sections which are oriented substantially perpendicularly with respect to one another and are configured in each case in such a way that in each case one connector section and one front end of the rod-shaped profile elements to be connected engage into one another, at least one transverse strut, the ends of which are configured in such a way that in each case one end of the transverse strut and one connecting section which is provided on a circumferential face of the rod-shaped profile elements to be connected engage into one another releasably, and a tensioning element which tensions the transverse strut releasably against the corner connector.

It has been surprisingly found that the corner connector according to the invention imparts particularly high stability to the frame constructions produced from it with rod-shaped profile elements, which stability in many cases far surpasses the stability of conventional connecting systems for rod-shaped profile elements. Here, the frame constructions which are produced by way of corner connectors according to the invention can be assembled and dismantled again particularly rapidly and simply.

The profile elements, for which the corner connector according to the invention is suitable, can have a very wide variety of general shapes in cross section, that is to say, for example, round, elliptical, polygonal, in particular rectangular or square. The profile elements can consist of a very wide variety of materials such as metal, plastic or wood, The profile elements can be present as solid material in the form of rods or as tubular hollow profiles. The abovementioned general shapes can be structured further with longitudinal structures, such as grooves, projections or ducts. In the present context, the term “rod-shaped” denotes profile elements, the length of which is multiple times greater than the greatest transverse dimension, that is to say for example is multiple times greater than the diameter in the case of profile elements with a circular cross section, or is multiple times greater than the longest side edge of the cross section in the case of profile elements with a rectangular cross section. Their length is typically at least 10 times, preferably at least 20 times greater than the greatest transverse dimension. Moreover, rod-shaped profile elements are profile elements, in which the transverse dimensions do not differ greatly. The transverse dimensions can be substantially identical, as in the case of profile elements with a round, square or regularly polygonal cross section. In the case of different transverse dimensions, such as, for example, in the case of profile elements with an irregularly polygonal cross section, the transverse dimensions, in this case that is to say the side lengths of the cross section, are preferably to differ by less than five times, preferably by at most twice the shortest side.

The connecting element can consist of any desired material which is suitable for the respective application, for example of metal, in particular of cast iron, stainless steel or aluminum, of plastic or of wood, and can be manufactured from a solid material or as a hollow body.

The two connector sections which are oriented substantially perpendicularly with respect to one another preferably interact with the front ends of the rod-shaped profile elements to be connected in such a way that the connector section either engages over the front end of the profile element or, vice versa, the front end of the profile element engages over the connector section of the connecting element. The profile element and the connector section of the connecting element therefore overlap in the end region of the profile element, which ensures a connection which can also absorb high transverse forces in contrast to the abovementioned prior art. At the same time, the correct orientation of the profile elements is also ensured in this way, which makes the construction of complex frame constructions possible. In contrast to the corner connector which is known from GB 2391802 A, the corner connector according to the invention requires merely one transverse strut for the connection of two profile elements on account of the overlap and guidance of connector section to associated profile element.

A “substantially perpendicular orientation” of the connector sections is understood to mean connector sections which enclose approximately a right angle, preferably an angle in the range from 80 to 100°, a right angle being particularly preferred. In the case of deviations from the right angle, however, further measures such as telescopically variable transverse struts and/or movable ends of the transverse struts can ensure that fixed tensioning of the profile elements by way of a transverse strut is nevertheless possible. However, a solution of this type is more complicated and more expensive, with the result that right angles are preferred.

The profile elements are fastened to the connecting element by virtue of the fact that in each case one end of the transverse strut and one connecting section which is provided on a circumferential face of the rod-shaped profile elements to be connected engage into one another releasably. A tensioning element which is first of all still loose makes it possible to assemble the two profile elements and the transverse strut. As soon as all parts engage into one another, the transverse strut is tensioned against the corner connector, with the result that the assembly which is formed in this way is fixed firmly. Since the tensioning element can also be loosened again, the construction which is formed in this way can also be released again easily by the user.

The transverse strut itself can be of rod-shaped, plate-shaped or wing-shaped configuration, or can be configured as an elongate, box-shaped component. In particular in cases, in which the ends of the transverse strut have a relatively great contact area with the profile elements to be connected, the shape of the ends of the transverse strut is preferably adapted to the outer shape of the profile elements. For example, a corresponding concave end face can be provided at the ends of the transverse strut in the case of round profile elements.

The transverse struts and the connecting sections which are provided on the rod-shaped profile elements preferably engage into one another in such a way that the corner connector and the rod-shaped profile elements to be connected are connected to one another in a positively locking manner. As a result of the positively locking connection, the components to be connected cannot be detached even when the tensioning element has not yet been tightened fixedly. In the case of a construction comprising a plurality of corner connectors, this makes it possible to tension the individual tensioning elements more and more fixedly in an alternating manner, with the result that tilting of the profile elements during the assembly can be avoided effectively.

According to one embodiment, the positively locking connection is achieved by virtue of the fact that projections are arranged at the ends of the transverse strut, which projections engage into bores which are cut out in the connecting sections of the circumferential faces of the rod-shaped profile elements. According to another embodiment, recesses are cut out at the ends of the transverse strut, into which recesses pins can engage which are arranged in the connecting sections of the circumferential faces of the rod-shaped profile elements. The projections and pins can either be configured in one piece with the transverse strut or the profile element or can be fastened as a separate component to the transverse strut or the profile element. The bores and pins can already be present in correspondingly manufactured profile elements. It is also possible, however, that the user is given, with respect to a profile element, corresponding instructions for making bores or pins on conventional, commercially available profile elements, for example in the form of a drilling stencil which fits the respective corner connector.

The connector section of the corner connector particularly preferably comprises connector elements, the cross section of which is adapted to the rod cross section of the rod-shaped profile elements. In this way, particularly effective and play-free guidance of the profile elements during tensioning of the arrangement is made possible. At the same time, protection against rotation of the profile element is ensured in this way in the case of profile elements with a non-circularly symmetrical cross section.

The connector elements can be configured in one piece with the connecting element. According to another embodiment, however, the connector elements are arranged exchangeably in the connector section of the corner connector. As a result, different profile elements can be connected by one and the same connecting element by way of the selection of the suitable connector elements.

The tensioning elements can be realized in a very wide variety of ways. It is crucial that the tensioning element acts on the transverse strut in such a way that, during the actuation of the tensioning element, the transverse strut pulls or presses the profile elements to be connected in the direction of the connecting element and fixes the construction firmly as a result. According to one embodiment, at least one of the tensioning elements comprises a screw which can be screwed into the corner connector. In one variant, the screw head bears directly or via a washer on the transverse strut here and presses the transverse strut in the direction of the connecting element when it is screwed in. At the same time, the ends of the transverse strut press the two profile elements in the direction of the connecting element.

According to another embodiment, at least one of the tensioning elements comprises a quick action tensioner, by way of which a similar effect can be achieved to that by way of the above-described screw. The variant with a quick action connector is preferred, in particular, in exhibition stand construction, where frames and frameworks having the corner connector according to the invention frequently have to be erected and dismantled again.

One particular advantage of the corner connector according to the invention is to be seen in the fact that it can be produced in a very wide variety of embodiments for two and more profile elements, with the result that not only two-dimensional frame constructions, but rather, in particular, also three-dimensional frames and frameworks can be realized by way of the corner connector according to the invention. In the preferred variant, in which the connector sections are oriented in each case perpendicularly with respect to one another, the connecting element can comprise either two, three, four, five or even six connector sections, with the result that two, three, four, five or six rod-shaped profile elements can be connected to one another by way of one connecting element. Here, in each case two adjoining connector elements are oriented substantially perpendicularly with respect to one another, and the profile elements which are mounted there can be connected to one another in each case by way of a transverse strut. In variants having more than two connector sections, each profile element is connected to at least one further profile element via a transverse strut. If a profile element has more than one neighboring profile element which is arranged at a right angle, the profile element can also be connected to two or more further profile elements via transverse struts depending on the structural conditions.

Moreover, the subject matter of the invention is an assembly system for rod-shaped profile elements, which assembly system comprises a plurality of, in particular two and more types of the corner connectors according to the invention, at least two of the corner connectors having a different number of connector elements. An assembly system of this type is suitable for the construction of complex two-dimensional and three-dimensional frame constructions. The profile elements can be specially adapted elements of the assembly system, or they can be conventional commercially available profile elements which still have to be treated correspondingly by the user, in order for it to be possible for them to interact with the transverse struts of the assembly system according to the invention.

Finally, the subject matter of the invention is also a two-dimensional or three-dimensional load-bearing or holding frame which is assembled from rod-shaped profile elements, at least two profile elements being connected to one another via a corner connector according to the invention. The external shape of the corner connectors according to the invention is preferably adapted to the rod-shaped profile elements to be connected, with the result that a visually and functionally pleasant overall shape of the frame with a surface which is as uniform as possible is produced after the assembly.

Accordingly, the invention also relates to a load-hearing or holding frame which is assembled from profile elements, in particular rod-shaped profile elements, at least two profile elements being connected to one another via a corner connector. The load-bearing or holding frame according to the invention is distinguished by the fact that the ends of the profile struts which are connected via the corner connector are connected to one another, moreover, via a releasable transverse strut which is tensioned against the corner connector.

Numerous advantages are associated with the solution according to the invention. Thus, a simple connecting element ensures a frame construction which is more stable than a correspondingly welded frame concentration. The load-bearing or holding frame according to the invention can be dismantled simply and can therefore be transported satisfactorily. The load-bearing or holding frame according to the invention can be constructed from simple standard elements, such as profile tubes. Polygons can also be produced in a stable manner by way of correspondingly constructed corner parts. Since the frame according to the invention does not have to be welded, materials can also be used which cannot be welded or can be welded only with difficulty. Therefore, the load-bearing or holding frame according to the invention can also consist, for example, of aluminum. Since, in contrast to the solution which is presented by the applicant in DE 197 34 350 C1, no inner frames which are clamped in the frame or other objects which are clamped in by way of a tensile cable construction are required for the stability of the frame, a greater variety in the frame construction is ensured by way of the load-bearing or holding frame according to the invention.

The releasable transverse strut is preferably connected to the profile struts in such a way that the transverse strut engages into openings which are cut out in the profile elements. As a result, no further fastening means are necessary for connecting the transverse strut to the profile elements. The transverse strut can be adapted at its ends by way of suitable shaping to optimized engagement into the openings of the profile elements. For example, the profile strut can have a lasered L-shaped end which engages into the opening of the profile elements. As an alternative, the profile strut can also be provided with a separate component in the form of a stopper which engages on one side into the end of the profile strut and cm the other side into the drilled hole.

The transverse strut is preferably tensioned against the corner connector by means of a screw or a quick action tensioner. To this end, the screw head lies on the transverse strut, for example via a washer or a locking washer; the other end of the screw engages with its external thread into an external thread which is provided in a bore of the corner connector. When the screw is screwed in, the transverse strut is pulled against the corner connector and at the same time pulls the profile elements against the corner connector. In this way, not only is a stable connection of the two profile elements to the corner connector and therefore among one another ensured, but rather at the same time the profile elements are also aligned into the angle which is predefined by way of the corner connector.

For particularly satisfactory guidance, the corner connector has in each case one pin which engages into the respective profile element.

According to one preferred embodiment, the load-bearing or holding frame comprises fastening means for installation elements. A very wide variety of installation elements can be used for the two-dimensional or three-dimensional load-bearing or holding frame according to the invention. Here, wall elements, panels, covers, screens or sheets, as are used, in particular, in exhibition stand construction, but also shelves and the like are to be mentioned merely by way of example. Flaps, doors or windows or else lighting and sound systems can also be used as installation elements depending on the application.

According to one embodiment, the fastening means comprise magnetic holders which can be arranged, for example, on or in the tensioning means, the connecting element and/or the profile elements. Magnetic holders are suitable, in particular, for mounting panels, covers and the like.

As an alternative or in addition, the fastening means can also comprise a holding rail. A groove is preferably made in the holding rail, into which groove, for example, the edge strip of a screen or a woven fabric can be inserted.

According to a further variant, the fastening means comprise elastically mounted holding pins. The holding pins can be configured, for example, as clamping pins, into which a panel-like installation element is inserted. On account of the elastic fastening of the holding pins to the frame, thermal or mechanical loads which act on the installation element can be compensated for effectively.

According to a further variant, the fastening means comprise first and second slots which are cut out in the frame, the installation element having, on each side which is connected to the frame, at least one first projection which engages into the first opening which is cut out in the frame, the longitudinal extent of the first opening corresponding substantially to the longitudinal extent of the first projection, and at least one second projection which engages into the second opening which is cut out in the frame, the longitudinal extent of the second opening being greater than the longitudinal extent of the second projection.

In other words, according to one preferred embodiment, at least one installation element which is supported by the frame is provided, the installation element having, on each side which is connected to the frame, at least one first projection which engages into a first opening which is cut out in the frame, the longitudinal extent of the first opening corresponding substantially to the longitudinal extent of the first projection, and at least one second projection which engages into a second opening which is cut out in the frame, the longitudinal extent of the second opening being greater than the longitudinal extent of the second projection.

It is also particularly advantageous that not only closed frames, but rather also open frame systems, for example brackets, can be constructed by way of the load-bearing or holding frames according to the invention.

The invention can be used in a very wide range of areas such as exhibition stand construction, steel construction, for example in railing construction, horticulture, but also in the production of housings of different size, of transportable frames and containers to stationary constructions, such as shelf systems, garages or storage rooms for vehicles, gardening tools, etc.

The invention will be explained in greater detail in the following text with reference to exemplary embodiments which are shown in the appended drawings, in which:

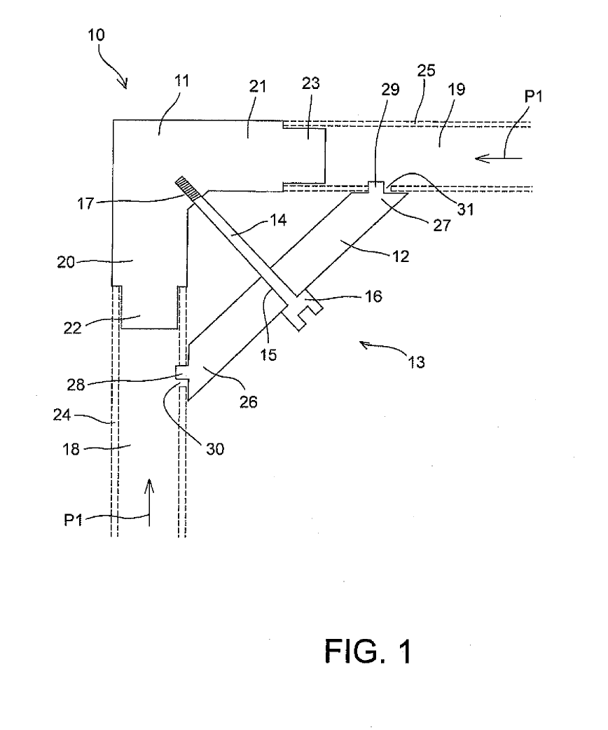

FIG. 1 shows a diagrammatic illustration of a first embodiment of a corner connector according to the invention for rod-shaped profile elements, in longitudinal cross section,

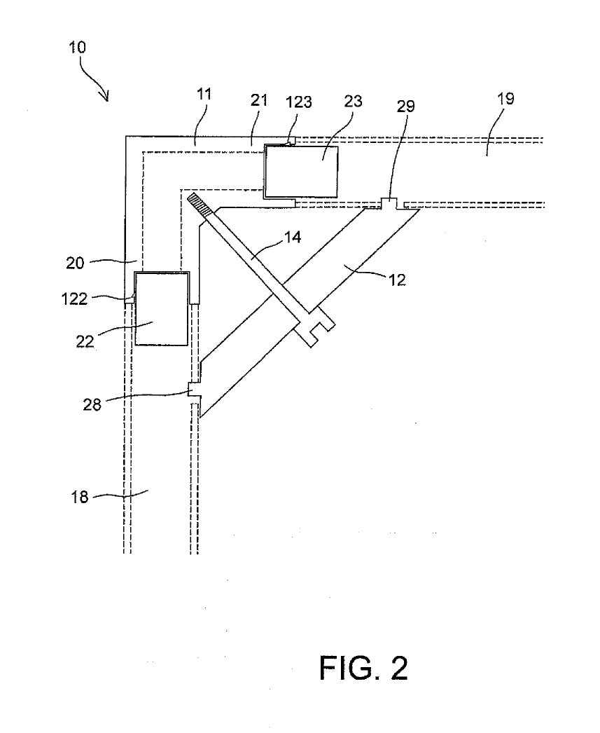

FIG. 2 shows a second embodiment of the corner connector according to the invention in a similar view to FIG. 1,

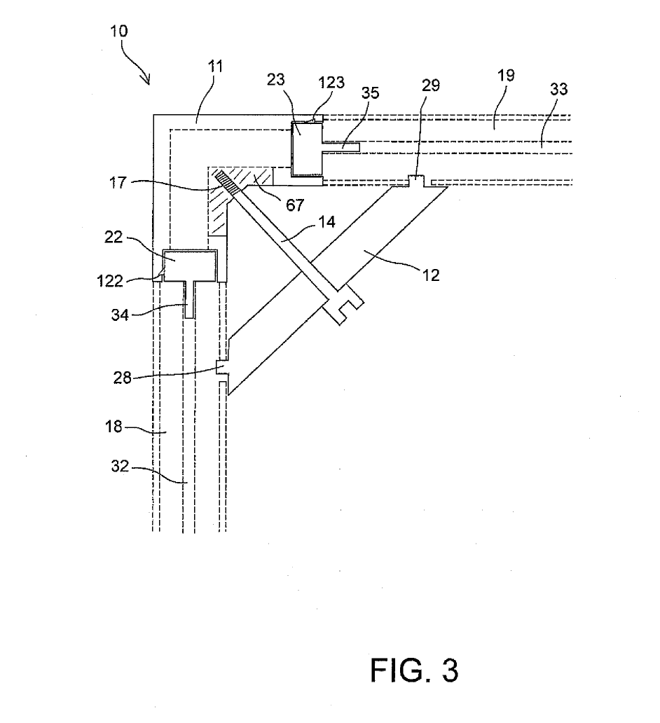

FIG. 3 shows a third embodiment of the corner connector according to the invention in a similar view to FIG. 1,

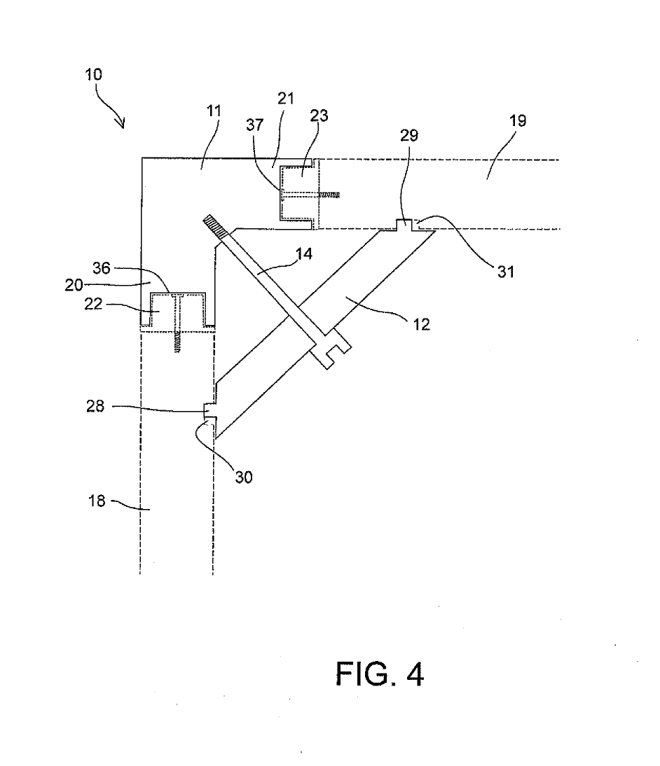

FIG. 4 shows a fourth embodiment of the corner connector according to the invention in a similar view to FIG. 1,

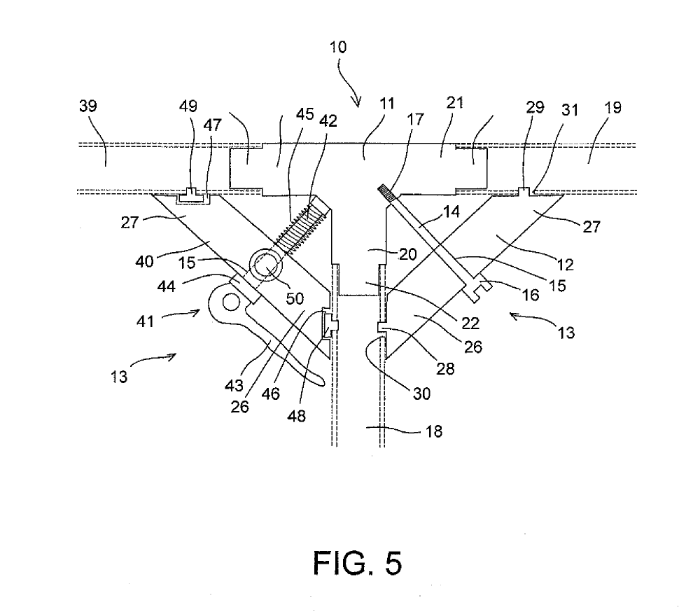

FIG. 5 shows a fifth embodiment of the corner connector according to the invention in a similar view to FIG. 1,

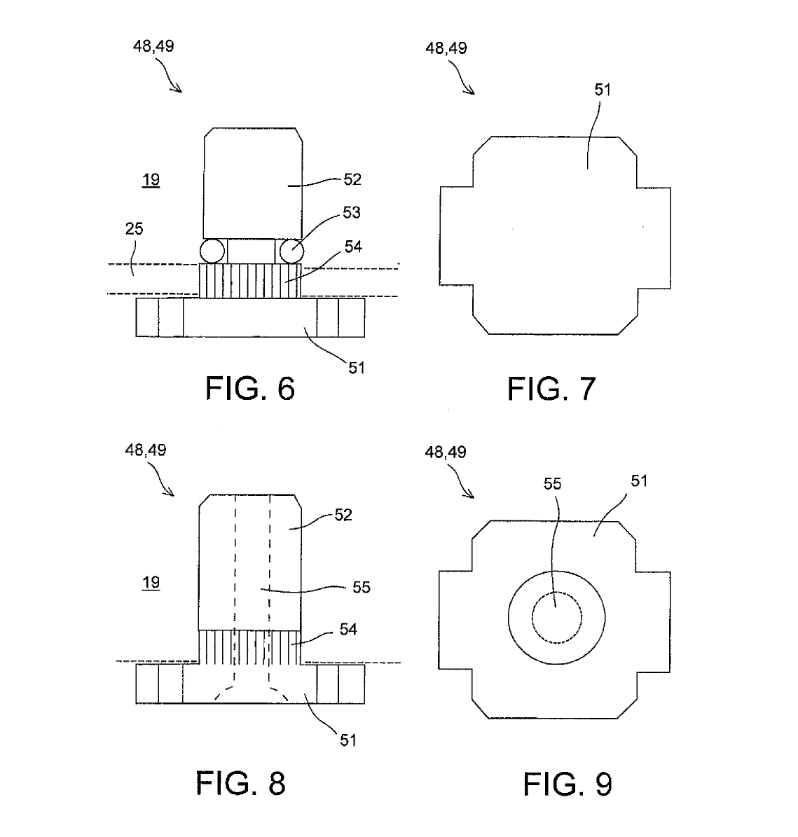

FIG. 6 shows a partial cross section of a first embodiment of the holding pin from FIG. 5,

FIG. 7 shows a plan view of the holding pin from FIG. 6,

FIG. 8 shows a partial cross section of a second embodiment of the holding pin from FIG. 5,

FIG. 9 shows a plan view of the holding pin from FIG. 8,

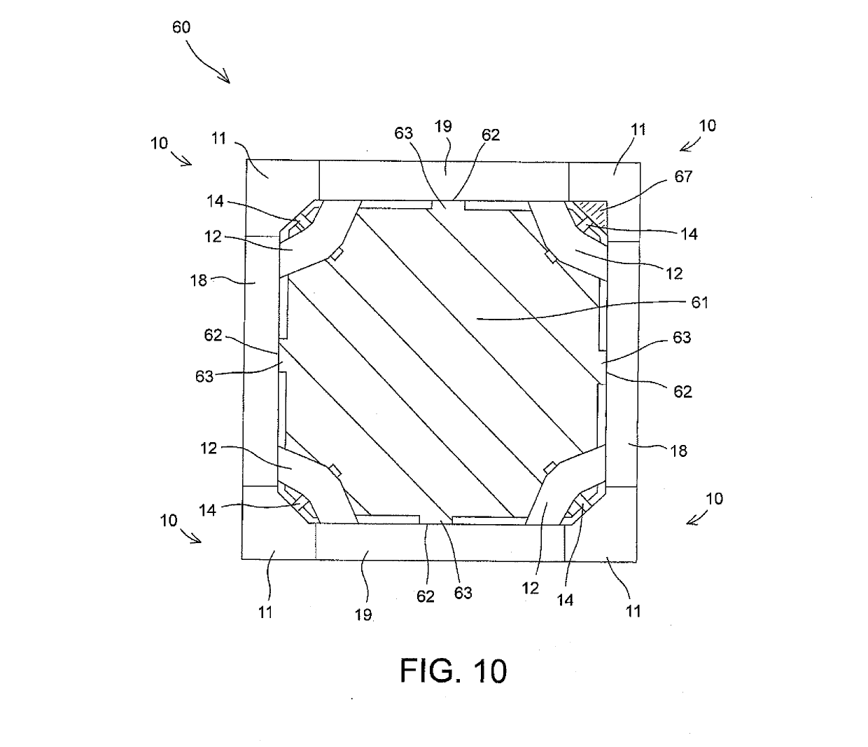

FIG. 10 shows a holding frame which is assembled from corner connectors according to the invention and rod-shaped profile elements, with an installation part, in a rear view,

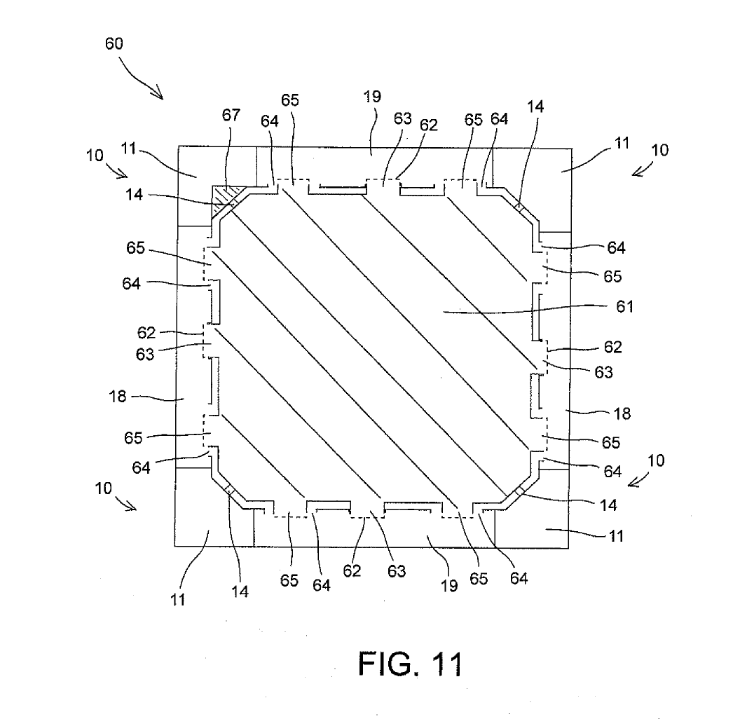

FIG. 11 shows a diagrammatic front view with part regions in the cross section of the holding frame from FIG. 10,

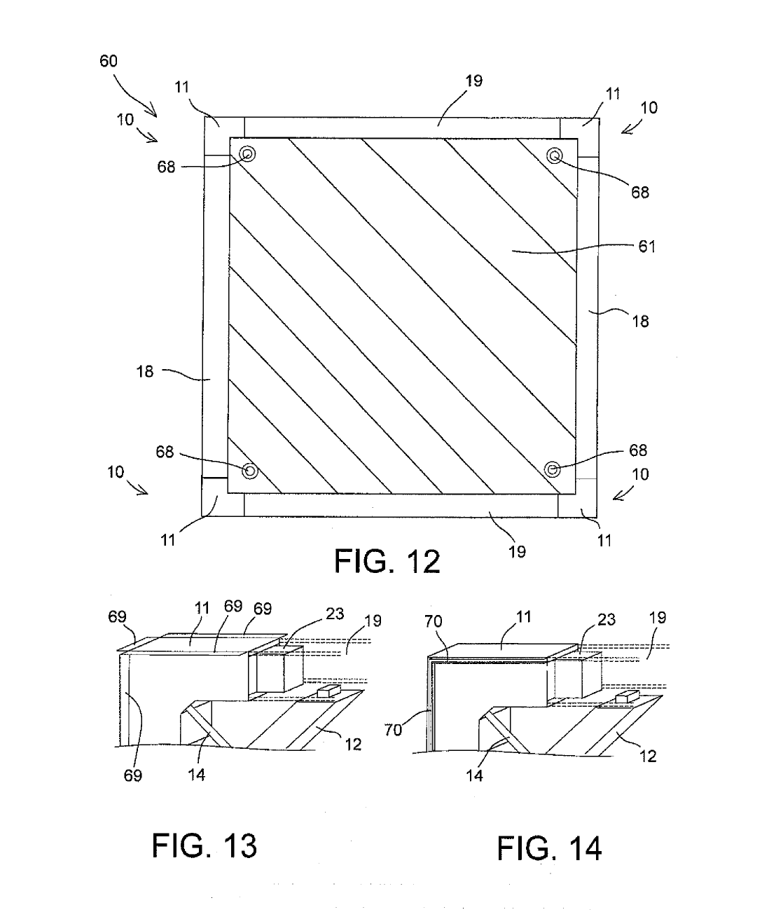

FIG. 12 shows a further embodiment of a holding frame according to the invention with an installation part,

FIG. 13 shows a perspective detailed view of one variant of the holding frame according to the invention with edge rails,

FIG. 14 shows a perspective detailed view of one variant of the holding frame according to the invention with a fastening groove,

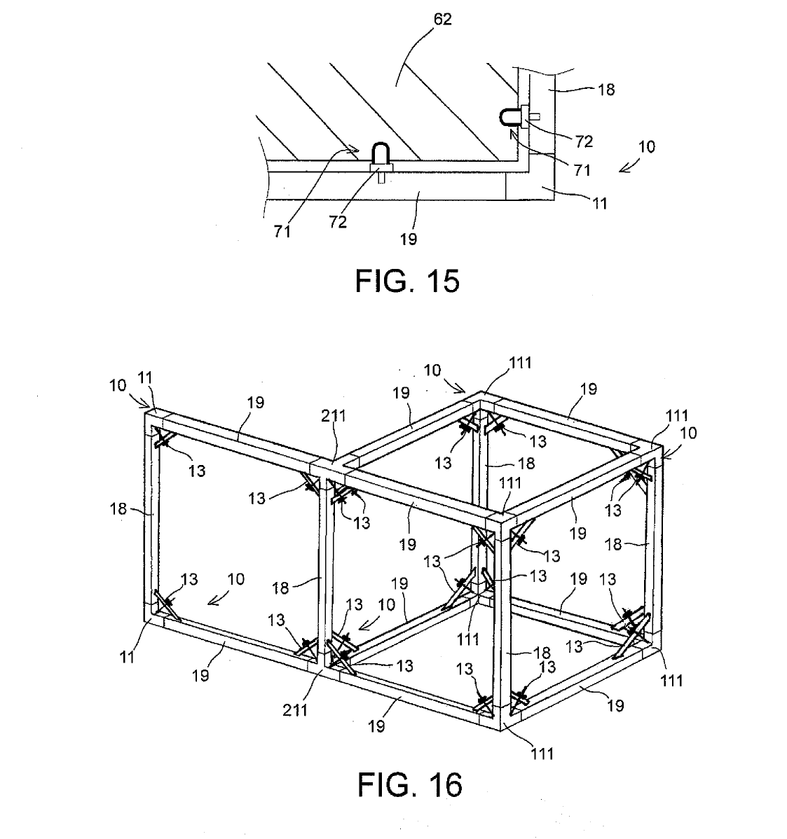

FIG. 15 shows a diagrammatic illustration of a further variant for fastening an installation part in the holding frame according to the invention, and

FIG. 16 shows a diagrammatic illustration of a three-dimensional frame which is assembled from different corner connectors according to the invention and rod-shaped profile elements.

In the following description, components which fulfill the same or a similar function are denoted by the same reference numerals, even if the specific configuration of the component can vary in the individual embodiments.

FIG. 1 shows a first embodiment of a corner connector 10 according to the invention for connecting rod-shaped profile elements. The corner connector 10 comprises a connecting element 11, a transverse strut 12 and a tensioning element 13. In the example which is shown, the tensioning element 13 consists of a hexagon socket screw 14 which is plugged through a bore 15 which is cut out in the transverse strut 12, and lies with its screw head 16 on the transverse strut 12. The hexagon socket screw 14 is screwed into a thread 17 which is cut out in the connecting element 11. In the example which is shown, two rod-shaped profile elements 18, 19 (shown using dashed lines in FIG. 1) are connected to one another at a 90° angle by way of the connecting element 11. To this end, the connecting element 11 has two arms 20, 21 which are arranged at a 90° angle with respect to one another and in each case have projections 22, 23 which engage into the rod-shaped profile elements 18, 19 to be connected. In the example which is shown, the outer walls 24, 25 of the rod-shaped profile elements 18, 19 engage around the projections 22, 23, with the result that the rod-shaped profile elements 18, 19 are guided on the projections 22, 23 as in the case of a conventional plug-in connection. A particularly stable corner connection of the two rod-shaped profile elements 18, 19 which by far surpasses conventional connections of rod-shaped profile elements is achieved by way of the transverse strut 12 which is provided according to the invention. The two ends 26, 27 of the transverse strut 12 interact with the two rod-shaped profile elements 18, 19 to be connected in such a way that, during tensioning of the tensioning element 13 (in the example which is shown, by way of the hexagon socket screw 14 being screwed into the thread 17 of the connecting element 11), the two rod-shaped profile elements are pulled toward the connecting element 11 in the direction of the arrows P1, P2.

In the example which is shown, in each case one bore 30, 31 is cut out in the rod-shaped profile elements 18, 19 to this end, into which bore 30, 31 in each case one projection 28, 29 which is arranged at the ends 26, 27 of the transverse strut 12 engages. As is gathered from the drawing, the bore 30, 31 is somewhat greater in the displacement direction P1, P2 than the respective projection 28, 29, with the result that the transverse strut 12 can be removed easily again when the tensioning element 13 is released.

The rod-shaped profile elements 18, 19 can be, for example, parts of a special system, where corresponding bores which are adapted to the respective corner connector have already been cut out. As an alternative, it is also conceivable that corner connectors are manufactured for customary commercially available profile elements, for example cylindrical or rectangular tubes or corresponding solid elements, and the user receives correspondingly adapted drilling stencils together with the corner connectors, with the aid of which drilling stencils he/she can produce the bores 30, 31 himself/herself. A system of this type is particularly flexible, since the length of the corresponding rod-shaped profile elements 18, 19 can be determined by the user himself/herself.

The corner connector 11 can consist of a solid material or can be configured as hollow parts (optionally with stabilizing ribs or struts). The external dimensions of the corner connector are preferably adapted to the rod-shaped profile elements to be connected, with the result that a flush impression is also produced visually. In cross section perpendicularly with respect to the longitudinal direction which is defined by way of the arrows P1, P2, the rod-shaped profile elements 18 and the corner connectors 11 which are optionally adapted to them can have a largely arbitrary shape, profile elements with a rectangular or round cross section being preferred.

FIG. 2 shows one variant of the corner connector from FIG. 1, in which both the profile tubes 18, 19 to be connected and the corner connector 10 are configured in each case as hollow elements. Instead of projections (cf. designations 22, 23 in FIG. 1) which are in each case fixedly connected to the profile element 11, the variant of FIG. 2 has two connector pieces 22 and 23 which engage in each case into the hollow profiles of the arms 20, 21 of the connecting element 11 and into the end-side openings of the rod-shaped profile elements 18, 19 to be connected. The two connector pieces 22, 23 are secured in the corner connector 11 via latching lips 122, 123.

A system of this type is particularly flexible, since, as shown, for example, in the variant of FIG. 3, an easy adaptation of one and the same connecting element 11 to different rod-shaped profile elements can take place by way of the use of different connector elements. Thus, in the example of FIG. 3, the profile elements 18, 19 which are shown there in each case have a central channel 32 and 33, into which a pin-shaped projection 34, 35 of the connector element 22, 23 engages.

Moreover, the variant of FIG. 3 shows that the thickness of the corner connector 11, which thickness is measured perpendicularly with respect to the plane of the drawing of FIG. 3, can be reduced in the region 67 of the thread 17, for example to a thickness which corresponds to the thickness which is still required for the introduction of the thread 17. As shown, in particular, in FIGS. 10 and 11, installation parts can be installed in this way into a frame which is produced from corner connectors according to the invention and rod-shaped profile elements and frameworks which do not protrude beyond the upper side and underside of the corner connectors.

Instead of the variant which is shown in FIG. 1, in which the connecting element 11 is provided with projections 22, 23 which engage into the rod-shaped profile elements 18, 19 to be connected, it goes without saying that the rod-shaped profile elements 18, 19 can also have projections at their end-side ends, which projections engage into corresponding cutouts in the arms 20, 21 of the connecting element 11. A variant of this type is preferred, in particular, when the rod-shaped profile elements to be connected consist, for example, of a solid material.

If the material of the profile elements consists of a soft or brittle material, it can also be provided that the corresponding projections are manufactured from a different, more resistant material. A variant of this type is shown in FIG. 4. There, the rod-shaped profile elements 18, 19 consist of a solid material comprising wood, while projections made from metal 22, 23 are screwed on the end side to the rod-shaped profile elements 18, 19 and engage into depressions 36, 37 which are cut out in the arms 20, 21 of the connecting element 11. In the case of profile elements which consist of soft material, the bores 30, 31 in the profile elements 18, 19 can be lined, for example, with a metal ring for reinforcing purposes. In a case of this type, however, recourse will preferably be made, instead of to bores, to the variant which is shown in FIGS. 5, 8 and 9 with screwed-in guide pins.

In the variants which are shown in FIGS. 1 to 4, the transverse strut 12 has in each case projections 28, 29 at its ends 26, 27, which projections 28, 29 engage into depressions/bores 30, 31 in the shell of the rod-shaped profile elements 18, 19. Conversely, a non-positive connection between the profile elements and the transverse strut can also be achieved by virtue of the fact that projecting pins are provided on the outer shell of the rod-shaped profile elements, which pins engage into suitable receptacles which are cut out at the ends 26, 27 of the transverse strut 12. Pins of this type can be configured in one piece with the respective profile element, for example shaped in a suitable manner, or can have been adhesively bonded, welded, screwed or attached in a non-positive and/or positively locking manner as a separate component to the outer shell of the profile elements. The latter variant, above all, will be explained in greater detail in the following text with reference to the embodiments of FIGS. 5-9.

In the embodiment of FIG. 5, the corner connector 10 has three arms 20, 21, 38, that is to say serves for connecting a total of three rod-shaped profile elements 18, 19, 39. In the example which is shown, the corner connector 10 is configured as a T-shaped connector, that is to say the profile elements 18, 19, 39 to be connected lie in one plane, In other variants, a corner connector for three profile elements can also have one arm which would be oriented perpendicularly with respect to the plane of the drawing in the illustration of FIG. 5, with the result that three-dimensional frames/frameworks would also be capable of being manufactured. In this case, the corner connector would form the corners of a cuboid. Correspondingly, more complex corner connectors for more than three profile elements are also conceivable. For example, proceeding from the corner connector which is shown in FIG. 5, variants of the corner connector can have additional arms which can be oriented, for example, upward in the plane of the drawing, that is to say lie opposite the arm 20, and/or forward and/or rearward perpendicularly with respect to the plane of the drawing. In this way, corner connectors can be constructed by way of the system according to the invention, to which corner connectors up to six transverse struts can be connected, of which in each case two are braced via right angles with the respective transverse struts. One example for a more complex, three-dimensional frame comprising corner connectors according to the invention will be explained in greater detail below in conjunction with FIG. 16.

In the embodiment of FIG. 5, two variants of the tensioning elements 13 and two variants of the connection between the ends of the transverse struts and the profile elements are shown. The tensioning element 13 which connects the rod-shaped profile elements 18 and 19 corresponds to the tensioning element which is shown in FIG. 1. In contrast to this, the tensioning element 13 which connects the profile elements 18, 39 consists of a transverse strut 40 which is tensioned against the corner of the arms 20, 38 of the connecting element 11 via a quick action tensioner 41. The quick action tensioner 41 comprises a guide pin 42 which is fixed in that corner of the connecting element 11 which is formed by the arms 20, 38, and passes through the transverse strut 40 and is connected to an eccentrically mounted tensioning lever 43, by way of which the transverse strut 40 can be tensioned via a plate 44 in the direction of the connecting element 11 counter to the force of a restoring spring 45 which is wound around the guide pin 42.

In contrast to the transverse strut 12, the transverse strut 40 does not have any projections at its ends 26, 27, but rather recesses 46, 47, into which pins 48, 49 engage which are fastened to the rod-shaped profile elements 18, 39. The recesses 46, 47 are of somewhat wider configuration than the head of the pins 48, 49, with the result that the transverse strut 40 can be released slightly during opening of the tensioning lever 43. During closing of the tensioning lever, the rear (in the direction of movement) part of the recess, as shown, forms a stop for the pin 48, 49 and thus presses the profile elements 18, 39 in the direction of the connecting element 11. It goes without saying that the pin variant which is shown here in conjunction with the quick action tensioner 41 can also be used in combination with a conventionally screwed transverse strut, for example in combination with the hexagon socket screw 14. The variant with quick action tensioner is preferred, in particular, for applications, in which the two-dimensional frame or the three-dimensional framework which is constructed in this way has to be erected and dismantled again rapidly, for example in exhibition stand construction. For applications of this type, holding elements can also be provided, for example, on the transverse strut, to which holding elements panels or other wall trims can be fastened. In the embodiment of FIG. 5, by way of example, a magnetic holder 50 is arranged on the upper side of the transverse strut 40, to which magnetic holder 50 a magnetic panel or non-magnetic panels which are provided with magnetic holding points can be fastened (cf. FIGS. 12 and 13). It goes without saying that a corresponding magnetic holder can also be provided on the opposite side of the transverse strut 40, with the result that the frame can be covered from both sides.

One particular advantage of the corner tensioner according to the invention can be seen in the fact that, in the case of rod-shaped profile elements with a polygonal cross section and connector sections which are adapted thereto at the ends 20, 21, 38 of the connecting elements 11 (projections 22, 23 or depressions 36, 37), an anti-rotation protection for the profile elements is ensured at the same time. In the case of rod-shaped profile elements with a round cross section, an anti-rotation safeguard can be ensured, for example, by virtue of the fact that the ends of the profile elements are provided with a guide rail or groove which, during the assembly, engages into corresponding grooves/rails which are cut out on the projections/depressions of the connecting elements. If, however, the corner connector according to the invention is to be used with commercially available tubes or solid material rods with a round cross section, an anti-rotation protection of the tube or the rod can also be ensured by virtue of the fact that the projection of the corner connector (cf. projection 23 on the arm 38 of the corner connector 11 in FIG. 5) is configured in such a way that it overlaps with the bore (designation 47 in FIG. 5) which is introduced into the rod-shaped profile element. The bore is then either configured to be so deep that it reaches as far as into the projection 23, or the projection 23 already has a correspondingly pre-manufactured bore or a longitudinal slot, with the result that the peg of the pin 49 reaches as far as into the bore or the longitudinal slot of the projection.

FIGS. 6-9 show two variants of the holding pins 48, 49 which are shown in FIG. 5. In the embodiment which is shown in FIGS. 6 and 7 in cross section and in plan view, respectively, the pin 48, 49 has a head 51 and a peg 52. The external diameter of the peg 52 corresponds substantially to the internal diameter of the bore/depression which is cut out in the rod-shaped profile element 18, 19, 39, and is pressed into the bore/depression in such a way that the head 51 lies on the outer side of the rod-shaped profile element. As holding device, the variant of FIGS. 6 and 7 has an elastic O-ring 53 which is compressed when being pressed in and can expand in the interior of the profile element and thus protects the pin 48, 49 from falling out of the bore. As anti-rotation safeguard, the pin 48, 49 can have a grooving 54 in that region of the peg 52 which immediately adjoins the head 51. Said grooving is situated directly at the level of the wall or the shell 25 of the rod-shaped profile element (indicated using dashed lines in FIG. 6) in the installed state. A variant of this type is preferably used in the case of hollow rod-shaped profile elements. In contrast to this, a variant as shown in FIGS. 8 and 9 is preferably used in the case of solid rod-shaped profile elements. The variant shown there of the pin 48, 49 corresponds substantially to the variant of the pin of FIGS. 6 and 7, except that a continuous bore 55 is provided instead of the O-ring 53, through which continuous bore 55 the pin 48, 49 can be screwed to the profile element. As an alternative to the variants which are shown, the pin 48, 49 which then consists merely of a head part 51 and a peg 52 can be adhesively bonded, welded, riveted or fastened in some other way in a bore/opening of the profile element.

FIG. 10 shows a rectangular holding frame 60 which is assembled from four profile elements 18, 19 which are connected to one another via in each case four corner connectors which comprise in each case one connecting element 11, one transverse strut 12 and one tensioning element 13 (indicated by way of a tensioning screw 14). In the example which is shown, an installation element which is configured as a panel 61 is inserted into the holding frame 60. As is gathered, in particular, from the rear view of FIG. 11, central slots 62 are cut out on each side of the frame, into which slots 62 first projections 63 of the panel 61 engage with an accurate fit. The central first slot 62 and the projections 63 fix the panel 61 in the holding frame 60 with an accurate fit. Second slots 64 are cut out at the ends of each profile element 18, 19, which second slots 64 are somewhat longer than the corresponding second projections 65 of the panel 61 which engage into the second slots 64. As a result, a certain play is possible between the ends of the panel 61 and the frame 60 which is produced from the profile element 18, 19, in the case of thermal and/or mechanical loading. Stress-induced bending of the panel 61 can thus be prevented effectively. In the example which is shown, the panel 61 is held at a certain spacing from the frame by way of corresponding dimensioning of the slots and projections.

In the example which is shown, the panel 61 has beveled corners 66. A solution of this type can be selected, for example, if the connecting element 11 has the same thickness (measured perpendicularly with respect to the plane of the drawing) as the profile elements 18, 19. It is also possible, however, to provide a connecting element with a lower thickness, for example, in the region which is denoted by designation 67, with the result that the panel 61 can also be of rectangular configuration without beveled corners. It is essential solely that the thinner region 67 still has a sufficient thickness, in order to receive the end of a tensioning screw 14 of the tensioning element 13 or to provide a stable mounting for a quick action tensioner 41.

FIG. 12 shows one variant of the holding frame 60 according to the invention, in which the panel 61 which is used terminates flush with the frame. To this end, the connecting elements 11 and optionally also the profile elements 18, 19 can have suitable bearing regions with a lower thickness, into which the panel can be inserted in a flush manner. In a case of this type, the system shown in FIGS. 10 and 11 comprising projections and slots is not used for fastening the panel 61, but rather recourse is made to another suitable holding system. In the case of a permanent installation, the panel 61 can be adhesively bonded or screwed, for example, to the connecting elements 11 and/or the rod-shaped profile elements 18, 19. As an alternative, fastening by way of clips, double sided adhesive tape or hook and loop fasteners may also be suitable. Magnetic fastening is particularly preferred, for example with the aid of magnetic holders (cf. designation 50 in FIG. 5) which are attached on the transverse struts 12. In a case of this type, corresponding holding magnets (designation 68 in FIG. 12) are then provided on one side of the panel, which holding magnets interact with the magnetic holders 50.

One particularly preferred variant is shown in FIG. 13, where the connecting element 11 and the rod-shaped profile element 19 are cut out in such a way that merely a thin circumferential web 69 surrounds the panel 61 at their edges, the depth of the web corresponding approximately to the thickness of the panel 61. In the assembled state, a frame or framework can then be constructed, in which merely the panels 61 can still be seen from the outside, and merely the thin web 69 remains visible between the panels. Depending on the requirement, the connecting elements 11 and the profile elements 18, 19 can be provided with webs of this type for inserting panels only on one side or on both opposite sides. As can be seen in FIG. 13, the end side of the installation elements 11 and the profile elements 18, 19 can also be provided with a corresponding web, with the result that a frame which is formed in this way can be covered from all sides. In this case, magnetic holders can be pushed, for example, into hollow profile elements 18, 19, which magnetic holders then hold a panel which is attached correspondingly on the outside.

FIG. 14 shows a further variant of the holding frame 60 according to the invention, in which a clamping rail 70 is attached on the front and/or rear side of the connecting elements 11 and optionally of the profile elements 18, 19, into which clamping rail 70, for example, an edge rail of an installation element 61 can be inserted. A mounting type of this type of the installation element is particularly preferred when the installation element 61 is a woven fabric which is provided with an edge rail, for example a stretched fabric or the like. The spacing of the installation element 61 from the frame can also be adapted by way of corresponding dimensioning of the edge rail, which is of particular interest if, for example, an illumination device, loudspeaker or the like is also to be arranged between the installation element 61 and the holding frame 60.

Finally, FIG. 15 shows a further fastening variant for panel-like installation elements. In this case, the panel 61 is held by way of slotted holding pens 71, into which the panel 61 is pressed. The holding pins 71 in turn are connected via elastic rings 72 to the rod-shaped profile element 18, 19. On account of the corner connector which is provided according to the invention, it is possible in this case to use single-piece pins 71, since the panel is already inserted during the assembly of the frame. The elastic rings 72 permit a certain mobility of the system in the case of thermally or mechanically induced stresses, with the result that a flat, wave-free arrangement of the panel 61 is ensured even in the case of a thermal expansion of the panel and/or the frame.

One particular advantage of the corner connecting system according to the invention is to be seen in the fact that frames and frameworks in a very wide variety of one-dimensional, two-dimensional and three-dimensional configurations can be produced rapidly and stably.

Finally, FIG. 16 therefore shows a three-dimensional frame which is assembled from profile elements which is produced by way of a very wide variety of variants of the corner connector according to the invention. In addition to corner connectors 11 for two profile elements 18, 19, as shown in conjunction with FIGS. 1 to 4, corner connectors 111 for three profile elements can be seen, in the case of which, in contrast to the T-shaped corner connector from FIG. 5, all three arms lie perpendicularly with respect to one another, however, with the result that they are suitable for the construction of three-dimensional frames. Finally, in the embodiment which is shown in FIG. 16, corner connectors 211 for profile elements 18, 19 are also used. In the example of FIG. 16, the tensioning elements 13 are shown merely very diagrammatically for the sake of improved clarity.

1-16. (canceled)

17. A corner connector for rod-shaped profile elements, comprising:
a connecting element, which comprises at least two connector sections which are oriented substantially perpendicularly with respect to one another and are configured in each case in such a way that in each case one connector section and one front end of the rod-shaped profile elements to be connected engage into one another,
at least one transverse strut, the ends of which are configured in such a way that in each case one end of the transverse strut and one connecting section which is provided on a circumferential face of the rod-shaped profile elements to be connected engage into one another releasably, and
a tensioning element which tensions the transverse strut releasably against the corner connector, the tensioning element comprising a screw which can be screwed into an internal thread which is cut out in the connecting element, or comprising a quick action tensioner.

18. The corner connector as claimed in claim 17, wherein the corner connector and the rod-shaped profile elements to be connected are connected to one another in a positively locking manner.

19. The corner connector as claimed in claim 18, wherein projections are arranged at the ends of the transverse strut, which projections can engage into bores which are cut out in the connecting sections of the circumferential faces of the rod-shaped profile elements.

20. The corner connector as claimed in claim 18, wherein recesses are cut out at the ends of the transverse strut, into which recesses pins can engage which are arranged in the connecting sections of the circumferential faces of the rod-shaped profile elements.

21. The corner connector as claimed in claim 17, wherein the connector section of the corner connector comprises connector elements, the cross section of which is adapted to the rod cross section of the rod-shaped profile elements.

22. The corner connector as claimed in claim 21, wherein the connector elements are arranged exchangeably in the connector section of the corner connector.

23. The corner connector as claimed in claim 17, wherein the connecting element comprises two, three, four, five or six connector sections, in each case two connector elements which adjoin one another being oriented substantially perpendicularly with respect to one another.

24. An assembly system for rod-shaped profile elements, which assembly system comprises a plurality of corner connectors as claimed in claim 23, at least two corner connectors having a different number of connector elements.

25. A load-bearing or holding frame which is assembled from rod-shaped profile elements, wherein at least two profile elements are connected to one another via a corner connector as claimed in claim 17.

26. The load-bearing or holding frame as claimed in claim 25, wherein the frame comprises fastening means for installation elements.

27. The load-bearing or holding frame as claimed in claim 26, wherein the fastening means comprise magnetic holders.

28. The load-bearing or holding frame as claimed in claim 26, wherein the fastening means comprise a holding rail.

29. The load-bearing or holding frame according to claim 26, wherein the fastening means comprise elastically mounted holding pins.

30. The load-bearing or holding frame as claimed in claim 26, wherein
the fastening means comprise first and second slots which are cut out in the frame,
the installation element having, on each side which is connected to the frame,
at least one first projection which engages into the first opening which is cut out in the frame, the longitudinal extent of the first opening corresponding substantially to the longitudinal extent of the first projection, and
at least one second projection which engages into the second opening which is cut out in the frame, the longitudinal extent of the second opening being greater than the longitudinal extent of the second projection.
